(19) United States
(12) Patent Application Publication
(10) Pub. No.: US 2013/0337576 A1
(43) Pub. Date: Dec. 19, 2013

(54) MICROFLUIDIC SYSTEM, CARTRIDGE AND METHOD FOR PREPARING SAMPLE

(71) Applicants: Li Zhu, Clifton Park, NY (US); Christopher Michael Puleo, Niskayuna, NY (US); Jessica Marie Godin, Niskayuna, NY (US)

(72) Inventors: Li Zhu, Clifton Park, NY (US); Christopher Michael Puleo, Niskayuna, NY (US); Jessica Marie Godin, Niskayuna, NY (US)

(73) Assignee: General Electric Company, Schenectady, NY (US)

(21) Appl. No.: 13/523,974

(22) Filed: Jun. 15, 2012

(51) Int. Cl. G01N 1/40; B01L 3/00

(52) U.S. Cl. 436/177; 422/502

(57) ABSTRACT

A microfluidic system for preparing a sample containing an analyte of interest is provided. The microfluidic system includes a microfluidic cartridge and a magnetic element. The microfluidic cartridge includes a number of reservoirs, an immobilizer, a number of microfluidic flow channels and a number of microvalves. The microfluidic channels are coupled with the reservoirs and the immobilizer. The microvalves are positioned along the microfluidic flow channels. The magnetic element is positioned with respect to the immobilizer. The magnetic element is configured to generate a magnetic field to magnetically immobilize the analyte of interest in the immobilizer. The immobilizer is configured to flow one or more reagents therethrough to react with the analyte of interest.

This invention was made with Government support under contract number N00173-08-2-0003 that was awarded by the Naval Research Laboratory. The Government has certain rights in the invention.

### BACKGROUND

Embodiments of the invention relate generally to a microfluidic system, cartridge and method and more particularly to a microfluidic system, cartridge and method for preparing samples automatically.

Samples containing analytes of interest are generally required to be prepared before loading into analytical instrumentations for analysis. For example, a flow cytometer is a powerful analytical instrument to analyze individual cells or particles for a wide range of applications spanning from cellular analysis to molecular and genomic analysis. Cells or particles need to be prepared before loading into the flow cytometer with a sample preparation procedure tailored to a specific application. Many commercially available flow cytometers are expensive, large bench top instruments that require an intensive manual sample preparation before sample loading. The manual sample preparation usually requires highly skilled personnel to carry out using long hours and at high cost and it requires additional lab equipment and resources. Some automation in sample preparation and handling has been realized by a large-scale robotic system. However, those robotics increase the system size, cost and complexity, making them not suitable for point-of-care applications.

It is desirable to provide a system, cartridge and method that can be integrated into an analytical instrument like a flow cytometer to provide rapid and automated sample preparation. In addition, it is also desirable to provide a microfluidic-based system that is compact, inexpensive and suitable for use at point-of-care.

### BRIEF DESCRIPTION

In accordance with one embodiment disclosed herein, a microfluidic system for preparing a sample containing an analyte of interest is provided. The microfluidic system includes a microfluidic cartridge and a magnetic element. The microfluidic cartridge includes a number of reservoirs, an immobilizer, a number of microfluidic flow channels and a number of microvalves. The microfluidic channels are coupled with the reservoirs and the immobilizer. The microvalves are positioned along the microfluidic flow channels. The magnetic element is positioned with respect to the immobilizer. The magnetic element is configured to generate a magnetic field to magnetically immobilize the analyte of interest in the immobilizer. The immobilizer is configured to flow one or more reagents therethrough to react with the analyte of interest.

In accordance with another embodiment disclosed herein, a microfluidic cartridge for preparing a sample containing an analyte of interest is provided. The microfluidic cartridge includes a number of reservoirs, an immobilizer, a number of microfluidic flow channels and a number of microvalves. The immobilizer is configured to immobilize an initial sample using a magnetic field. The microfluidic flow channels are coupled with the reservoirs and the immobilizer and configured to pass one or more reagents from one or more of the reservoirs through the immobilizer to forma prepared sample. The microvalves are positioned along the microfluidic flow channels for controlling the flow of the one or more reagents.

In accordance with another embodiment disclosed herein, a method for preparing a sample automatically in a microfluidic cartridge is provided. The method includes introducing an initial sample into an immobilizer. The method further includes immobilizing the initial sample in the immobilizer by a magnetic field. And the method further includes introducing one or more reagents from one or more reagent reservoirs through the immobilizer to react with the initial sample to form a prepared sample while the one or more reagents flow through the immobilizer. The method further includes releasing the prepared sample into a downstream analysis portion by removing the magnetic field from the immobilizer.

### DRAWINGS

These and other features, aspects, and advantages of the present invention will become better understood when the following detailed description is read with reference to the accompanying drawings in which like characters represent like parts throughout the drawings, wherein:

FIG. 1 is a top view of a sample preparation portion of a microfluidic cartridge according to one embodiment of the invention;

FIG. 2 is a perspective view of a microfluidic system according to one embodiment of the invention;

FIG. 3 is a perspective view of an embodiment of a magnetic element of the microfluidic instrument of FIG. 2;

FIG. 4 is a schematic drawing of the microfluidic cartridge in accordance with one embodiment of the invention; and

FIG. 5 is a schematic flow chart of a method preparing a sample using the microfluidic instrument in accordance with one embodiment of the invention.

FIG. 6 is a schematic flow chart of the method preparing a sample using the microfluidic instrument in accordance with another embodiment of the invention.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The use of “including,” “comprising” or “having” and variations thereof herein are meant to encompass the items listed thereafter and equivalents thereof as well as additional items. Although the terms “connected” and “coupled” are often used to describe physical or mechanical connections or couplings, they are not intended to be so restricted and can include electrical connections or couplings, whether direct or indirect. Moreover, the terms “connected” and “coupled” may refer to physical or mechanical connections or couplings that together allow a carrier fluid or liquid to flow therein.

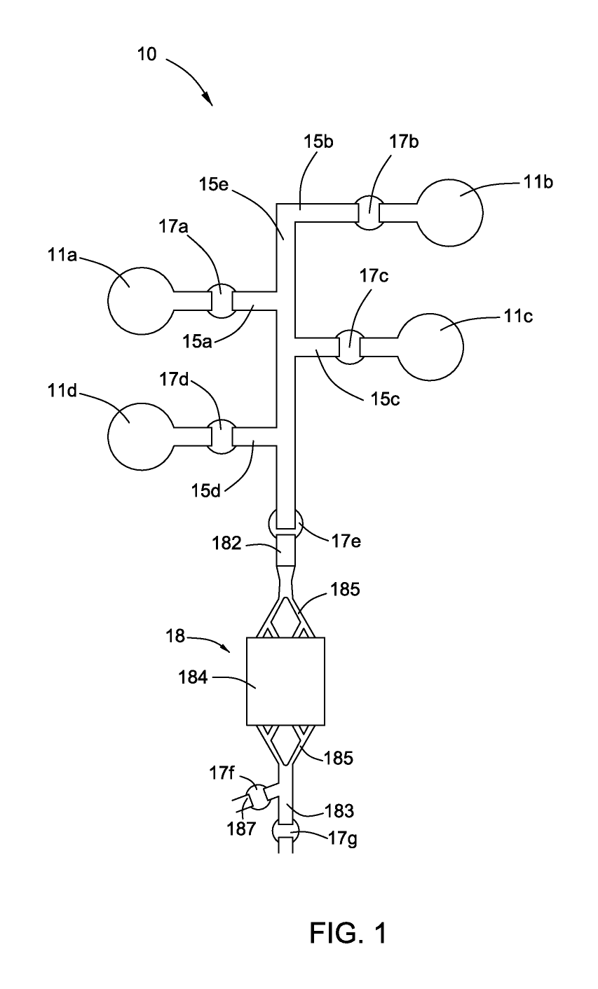

FIG. 1 illustrates a top view of a sample preparation portion 10 of a microfluidic cartridge in accordance with an exemplary embodiment. The sample preparation portion 10 includes a number of reservoirs 11a-11d, an immobilizer 18, a number of microfluidic flow channels 15a-15e coupling the reservoirs 11a-11d with the immobilizer 18, and a number of microvalves 17a-17e positioned along the microfluidic flow channels 15a-15e so as to control fluid flow within the flow channels. As used herein, the term “along” is intended to mean “over the course of” or “adjacent to” and does not necessarily require that the microvalves be positioned in the flow channels. For example, although the microvalves may be located in the flow channels, they may also be positioned above or below the plane of an associated flow channel such that when pressure is applied to or removed from the microvalves, the microvalve closes or opens the channel. The reservoirs 11a-11d may represent one or more sample reservoirs configured to store an initial sample to be processed and one or more reagent reservoirs configured to store reagents which are used to process the initial sample. The initial sample and the reagents may be stored completely within the microfluidic cartridge, or the initial sample and/or one or more of the reagents may be stored separately from the microfluidic cartridge and introduced from an external source during the sample preparation process. The initial sample and the reagents may be introduced from an external source into the sample preparation portion 10 of the microfluidic cartridge by way of an access port coupled or aligned with a reservoir (11a-11d), a flow channel (15a-15e), or a microvalve (17a-17e), for example. The reagents stored in the microfluidic cartridge (e.g., in a reservoir) could be stored in either a liquid form or a dried form. Dried reagents stored on the cartridge have benefits of long term stability, ease of storage and ease of use. The dried reagents can be re-dissolved or reconstituted using water, for example. The initial sample may include one or more background matrices and one or more analytes of interest present in the background matrices. The background matrices may be blood, nasal wash, other bodily fluids or environmental matrices for example. The analytes of interest may be various classified organisms such as bacteria, viruses, cells or proteins, or nucleic acids, for example.

In one embodiment, magnetic particles adapted to capture the analyte of interest are used in conjunction with the initial sample as part of the sample preparation process. In one embodiment, the magnetic particles are functionalized such that the analyte of interest binds to the magnetic particles through functionalized surfaces on the magnetic particles that provide specific or non-specific binding moieties. In one embodiment, the magnetic particles comprise functionalized magnetic beads having a size on the order of 1˜10 μm, for example. The magnetic particles may be premixed with and stored with the initial sample or the magnetic particles and the initial sample may be stored separately and combined only during the sample preparation process. In an embodiment where the initial sample and the magnetic particles are stored together, they may be stored in a sample reservoir on the microfluidic cartridge or in a container separate from the microfluidic cartridge and injected into the microfluidic cartridge as part of the sample preparation process. In an alternative embodiment, the magnetic particles and the initial sample may be stored in isolation from each other and mixed only during the sample preparation process. In this case, the initial sample and/or the magnetic particles may be stored on or off of the microfluidic cartridge. In one embodiment, the magnetic particles may be loaded into and stored in a reagent reservoir prior to reacting with the analyte of interest. For the purpose of explanation, the reservoirs 11b-11d will be described as representing reagent reservoirs, while reservoir 11a will be described as representing a sample reservoir. However, in practice, the initial sample and reagents may be stored in different reservoirs and greater or fewer numbers of reservoirs may be used. The reservoirs may store one or more types of reagents such as buffer agents and various labeling agents.

The microfluidic flow channels 15a-15e include a main channel 15e and a number of branching channels 15a-15d. The main channel 15e is coupled with the immobilizer 18 and each of the branching channels 15a-15d respectively couple each of the reservoirs 11a-11d to the main channel 15e, so the reservoirs 11a-11d are in fluid communication with the immobilizer 18. As used herein, the term “channel” is used to refer to a fluid path. In some embodiments a channel may represent a continuous fluid path while in other embodiments a channel may represent a discontinuous fluid path. A discontinuous fluid path may include one or more features or protrusions which in coordination with the microvalves function to block or enable fluid flow. The microvalves 17a-17d are respectively positioned within or adjacent to each of the branching channels 15a-15d between each respective reservoir 11a-11d and the main channel 15e to control the flow of reagents and samples from the reservoirs 11a-11d into the main channel 15e. Further, the microvalve 17e is positioned at an end of the main channel 15e near the immobilizer 18 to control the flow of material into the immobilizer 18. In one embodiment, the microvalves 17a-17e represent microfluidic components that may each be independently controlled by a fluidic controller (not shown). In one embodiment, the fluidic controller includes one or more computer-controlled pumps to pneumatically control the microvalves 17a-17e The pumps are connected to each of the microvalves 17a-17e via small tubes (not shown) which are located off of the microfluidic cartridge. Pressure and vacuum are applied by the pumps to the microvalves 17a-17e through the tubes so as to control the microvalves 17a-17e. In one embodiment, the microvalves 17a-17e are initially closed and are subsequently actuated one at a time, so that the initial sample and the reagents can be injected sequentially into the immobilizer 18.

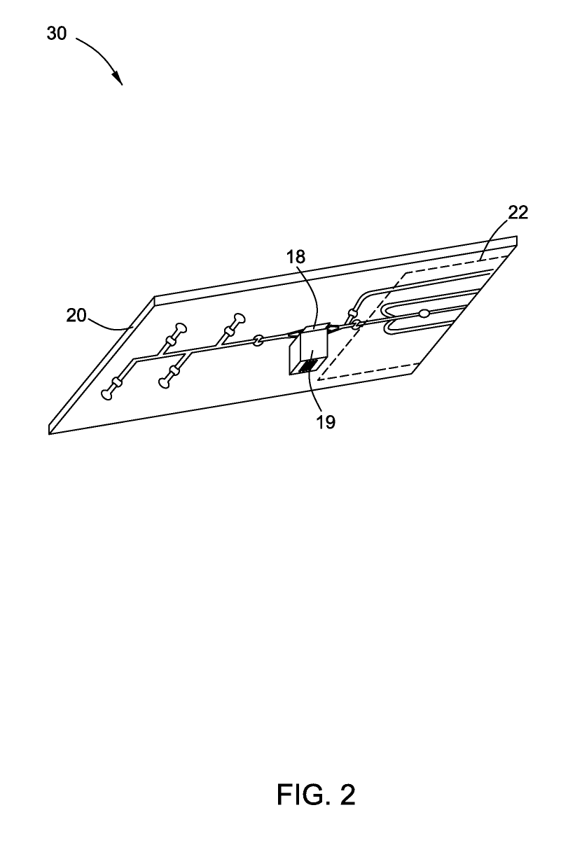

FIG. 2 illustrates a perspective view of a microfluidic system 30 in accordance with an exemplary embodiment. The microfluidic system 30 includes the microfluidic cartridge 20 including the sample preparation portion 10 of FIG. 1 along with a removable magnetic element 19 to generate a magnetic field. Referring to FIGS. 1 and 2, the magnetic element 19 may be positioned with respect to the immobilizer 18 such that the generated magnetic field can magnetically couple with and immobilize the magnetic particles in a trapping area 184 as they pass through the immobilizer 18. In one embodiment, the magnetic element 19 may be positioned adjacent to and removed from the microfluidic cartridge 20 to magnetically couple and decouple with the magnetic particles, respectively. The magnetic element 19 may be manually positioned or may be programmatically positioned via an actuator, for example. In one embodiment, the magnetic element 19 comprises an array of distributed magnetic point-sources or mini-magnets, each of which generates a magnetic field. The immobilizer 18 includes an inlet 182, an outlet 183, the trapping area 184 between the inlet 182 and the outlet 183, and a number of branching flow ducts 185. The inlet 182 connects with the main channel 15e and the outlet 183 connects with a downstream analysis portion 22 of the microfluidic cartridge 20. A microvalve 17g is set between the outlet 183 and the analysis portion 22. The microvalve 17g is also initially closed and represents a microfluidic component that is controlled by the fluidic controller (not shown). The branching flow ducts 185 couple the inlet 182 with the trapping area 184 and couple the trapping area 184 with the outlet 183. The initial sample and the reagents pass along the branching flow ducts 185 into the trapping area 184. In one embodiment, the branching flow ducts 185 coupled to the inlet 182 act to uniformly distribute the magnetic particles throughout the immobilizer 18 to prevent clumping. In one embodiment, the branching flow ducts 185 coupled to the inlet 182 are designed to distribute the magnetic particles uniformly in relation to the positioning of the magnetic element 19. For example, in embodiments where the magnetic element 19 comprises an array of mini-magnets, the branching flow ducts 185 may be designed to uniformly distribute the flow of magnetic particles around the mini-magnets facilitating greater magnetic particle separation during immobilization. In one embodiment, a monolayer spread of the magnetic particles is created. Further, a discharge channel 187 is coupled with the outlet 183 of the immobilizer 18 to discharge the reagents from the trapping area 184. In one embodiment, a microvalve 17f is set within the discharge channel 187 to control the flow of the reagents. The microvalve 17f is also initially closed and represents a microfluidic component that is controlled by the fluidic controller (not shown). In one embodiment, the reagents are uniformly and sequentially flowed into the trapping area 184 through the branching flow ducts 185 and passed through the trapping area 184 over/around the analyte of interest and the magnetic particles to react with the analyte of interest, and then the reagents are flowed out of the discharge channel 187 to waste.

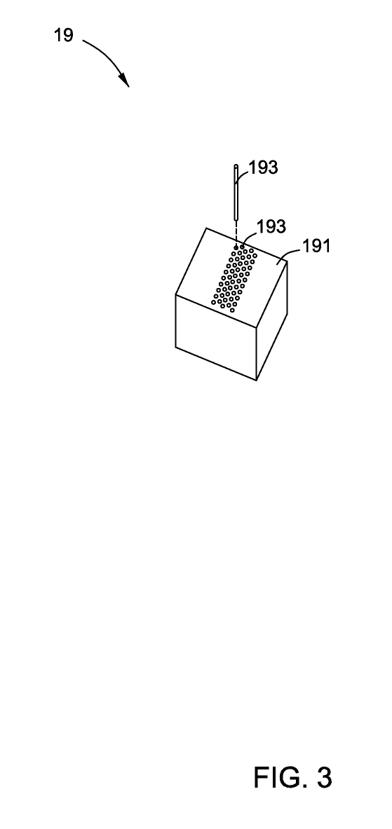

FIG. 3 illustrates a perspective view of one embodiment of the magnetic element 19. The magnetic element 19 is configured to create a magnetic field over the trapping area 184 and may be removably positioned near the immobilizer 18. The magnetic element 19 includes a base 191 and an array of mini-magnets 193 assembled in the base 191. The base 191 may be made of plastic or other non-magnetic materials, such as photocurable resins, polymers, copper and aluminium, while the mini-magnets 193 may be made of magnetic material, such as a rare earth metal material. In the illustrated embodiment, each of the mini-magnets 193 is a thin cylinder, axially-polarized magnet, having a diameter of about 1 millimeter and a length of about 3 mm. Moreover, the spacing between any two adjacent mini-magnets 193 may be about 300 μm, but may also vary depending upon the application and magnetic particle size, for example. In the illustrated embodiment, the mini-magnets 193 are arranged in a hexagonal lattice to provide efficient trapping when the magnetic particles pass through the immobilizer 18 in a straight line. However, in other embodiments, each adjacent row of the mini-magnets 193 may be aligned with one another. In one embodiment, common poles of the mini-magnets 193 are aligned within the array such that a field gradient is created across the mini-magnets 193 so as to provide uniform magnetic particle spreading in the trapping area 184 when the magnetic element 19 is placed near the microfluidic cartridge 20. The mini-magnets 193 are arranged densely enough to allow the trapping area 184 to be substantially covered by the generated magnetic field.

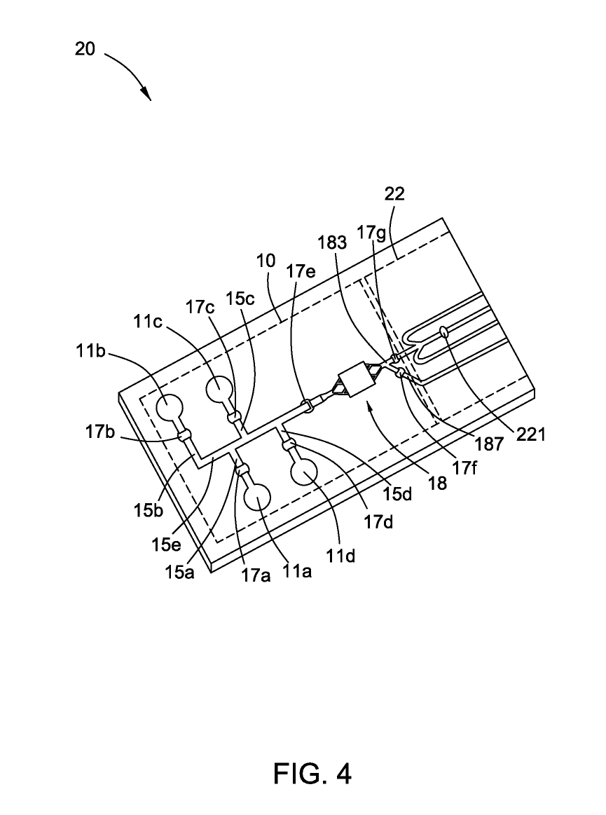

FIG. 4 illustrates one embodiment of the microfluidic cartridge 20. The microfluidic cartridge 20 includes the sample preparation portion 10 and the analysis portion 22. The sample preparation portion 10 includes the reservoirs 11a-11d, the microfluidic flow channels 15a-15e, the microvalves 17a-17g and the immobilizer 18 as the magnetic element 19 is located adjacent to the microfluidic cartridge 20. The sample preparation portion 10 is configured to process the initial sample to obtain a prepared sample for downstream analysis. The analysis portion 22 is coupled with the immobilizer 18 such that the prepared sample is released and flowed through the outlet 183 of the sample preparation portion 10 into the analysis portion 22. In doing so, the prepared sample passes through an interrogation area 221 of the analysis portion 22 to be detected by an analytical detection instrument (not shown) using optical, electrical means or other means. In the illustrated embodiment, the sample preparation portion 10 and the analysis portion 22 are integrated into the single microfluidic cartridge 20. In certain embodiments, the sample preparation portion 10 and the analysis portion 22 are integrated into separate microfluidic cartridges which are connected with each other to allow fluid to move from the sample preparation portion 10 to the analysis portion 22. In one embodiment, the analysis portion represents a microfluidic flow cytometer.

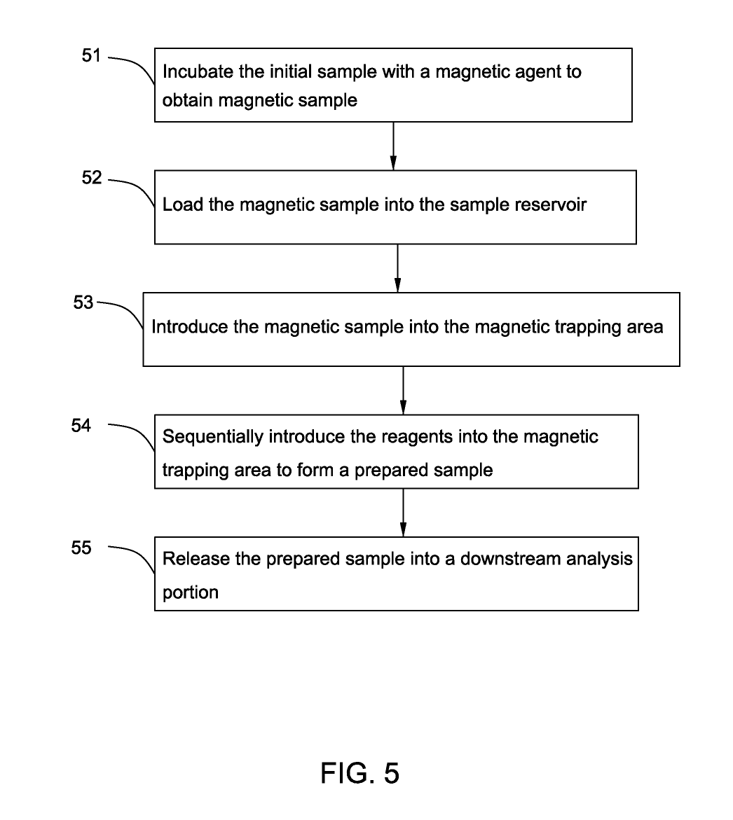

FIG. 5 is a schematic flowchart of a method for preparing a sample using the microfluidic system 30 in accordance with an exemplary embodiment. In step 51, the initial sample is incubated with a magnetic agent such as the magnetic particles to obtain a magnetic sample. The analyte of interest of the initial sample is captured by the magnetic particles through a ligand or capture moiety functionalized on the surface of the magnetic particles. In step 52, the magnetic sample is loaded into the sample reservoir 11a. In step 53, the microvalves 17e and 17a are controlled to open and the magnetic sample is introduced into the trapping area 184. The magnetic sample is magnetically immobilized by a magnetic field and with a uniform spread in the trapping area 184.

In step 54, the reagents are sequentially introduced from the reagent reservoirs 11b-11d into the trapping area 184. In one embodiment, the microvalve 17f is controlled to open and the microvalves 17b-17d are actuated sequentially to open such that the stored reagents are sequentially introduced from the reagent reservoirs 11b-11d into the trapping area 184. As previously noted, the reagents could be initially stored in either a liquid form or a dried form and then reconstituted into fluid form. The liquefied reagents are sequentially flowed through and react with the magnetic sample immobilized in the trapping area 184 to generate the prepared sample, as the excess reagents are flowed out of the discharge channel 187. The microvalve 17f is controlled to open before the first reagent is flowed out of the discharge channel 187 and is controlled to close after the last reagent is flowed out of the discharge channel 187. In a specific embodiment, the microvalves 17b and 17e are controlled to open and a first reagent such as a buffer agent is flowed from the reagent reservoir 11b and through the trapping area 184 and then flowed out of the discharge channel 187. Next, the microvalve 17c is controlled to open and a second reagent, such as tracer-antibodies, is flowed through the trapping area 184 to react with the sample, and flowed out of the discharge channel 187. Finally, the microvalve 17d is controlled to open and a third reagent, such as a fluorescent label, is flowed through the trapping area 184 to react with the sample and then flowed out of the discharge channel 187 resulting in a prepared sample. In certain embodiments, other types of reagents may be introduced to react with the initial sample, for example, one type of labeling agent may be introduced to quantify the analyte of interest. In one embodiment, some amount of liquid from the initial sample and the reagents is left in the reservoirs 11a-11d, so as to prevent air from flowing into the sample preparation portion 10. In step 55, once the initial sample has been processed into a prepared sample in the trapping area 184, the microvalve 17f is controlled to close, the microvalve 17g is controlled to open, and the prepared sample is then released and flowed into the analysis portion 22 through the outlet 183. In one embodiment, the prepared sample is released by removing the magnetic field generated by the magnetic element 19. In one embodiment, the magnetic field is removed by physically moving the magnetic element 19 away from the immobilizer 18. However, in other embodiments, a mechanical actuator or an electromagnet could be used.

Such a dynamic sample preparation process using flow through reactions allows continuous and constant concentration of the flowing reagents to interact with the immobilized sample. This results in a more uniform and efficient reagents-sample interaction in a certain time duration as compared to the conventional, manual static incubation in a chamber, leading to a shorter reaction time. In addition, in a typical manual sample preparation process involving one or more reagents to react or be incubated with the sample, washing steps in between incubations are essential to remove any non-specifically bounded agents to reduce the background noise. A flow through reaction such as that described herein, however, enables a wash-free process since the continuously flowing reagents sweep away the non-specifically bound agents resulting from the previous reaction step. Furthermore, in such a flow through reaction, a previous reagent is more likely to be completely removed by the incoming reagents as compared to the manual static incubation where the addition or removal of reagents occurs in a chamber or other container rendering complete removal of previous reagents difficult.

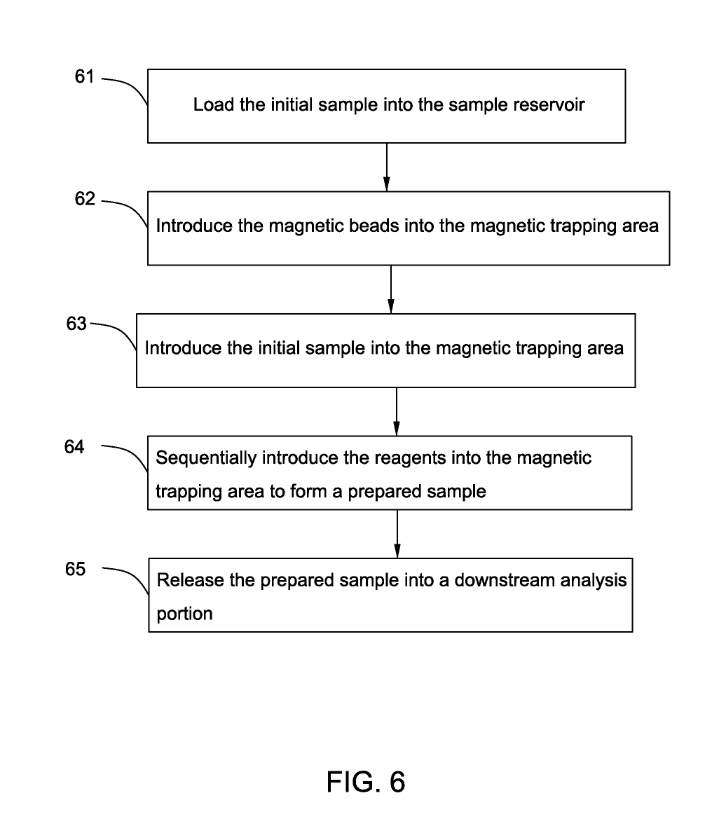

FIG. 6 is a schematic flowchart of the method for preparing a sample using the microfluidic system 30 in accordance with another embodiment. In step 61, the initial sample is loaded into the sample reservoir (e.g., 11a) and the magnetic particles are stored in an additional reagent reservoir (e.g., reservoir 11b-11d). In step 62, the magnetic particles are introduced into the trapping area 184 and are immobilized in the trapping area 184 by the magnetic field generated by the magnetic element 19. In accordance with one embodiment, the magnetic particles are pneumatically pumped out of the reagent reservoir and into the trapping area 184. In step 63, the initial sample is flowed into the trapping area 184 and captured by the magnetic particles through a ligand or capture moiety functionalized on the surface of the magnetic particles, for example. The step 64 is similar to the step 54 illustrated in FIG. 5. In step 64, the reagents are sequentially flowed into the trapping area 184 to react with the initial sample and flowed out of the discharge channel 187. In step 65, the prepared sample is then released from the trapping area 184 and is flowed into the analysis portion 22.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A microfluidic system for preparing a sample containing an analyte of interest, comprising:
a microfluidic cartridge comprising,
a plurality of reservoirs;
an immobilizer;
a plurality of microfluidic flow channels coupled with the plurality of reservoirs and the immobilizer; and
a plurality of microvalves positioned along the plurality of microfluidic flow channels; and
a magnetic element positioned with respect to the immobilizer, the magnetic element being configured to generate a magnetic field to magnetically immobilize the analyte of interest in the immobilizer, the immobilizer being configured to flow one or more reagents therethrough to react with the analyte of interest.

2. The microfluidic system of claim 1, wherein the magnetic element comprises an array of mini-magnets.

3. The microfluidic system of claim 2, wherein the mini-magnets are arranged in a hexagonal lattice.

4. The microfluidic system of claim 2, wherein each adjacent row of the mini-magnets is aligned with one another.

5. The microfluidic system of claim 2, wherein common poles of the mini-magnets are aligned within the array.

6. The microfluidic system of claim 1, wherein the magnetic element is removably positioned near the immobilizer.

7. The microfluidic system of claim 1, wherein the immobilizer comprises an inlet, an outlet, a trapping area between the inlet and the outlet and a plurality of branching flow ducts coupling the inlet with the trapping area and coupling the trapping area with the outlet.

8. The microfluidic system of claim 7, wherein the microfluidic cartridge further comprises an analyzer coupled to the outlet of the immobilizer to receive and flow the analyte of interest to an interrogation area for analysis.

9. The microfluidic system of claim 8, wherein the analyzer is a flow cytometer.

10. The microfluidic system of claim 8, wherein the microfluidic cartridge further comprises a discharge channel coupled with the outlet of the immobilizer, the discharge channel being configured to flow the one or more reagents out thereof to waste away from the analyzer.

11. A microfluidic cartridge for preparing a sample containing an analyte of interest, the microfluidic cartridge comprising:
a plurality of reservoirs;
an immobilizer configured to immobilize a sample using a magnetic field;
a plurality of microfluidic flow channels coupled with the plurality of reservoirs and the immobilizer, the plurality of microfluidic flow channels configured to pass one or more reagents from one or more of the plurality of reservoirs through the immobilizer to form a prepared sample; and
a plurality of microvalves positioned along the plurality of microfluidic flow channels for controlling the flow of the one or more reagents.

12. The microfluidic cartridge of claim 11, wherein the immobilizer comprises an inlet, an outlet, a trapping area between the inlet and the outlet and a plurality of branching flow ducts coupling the inlet with the trapping area and coupling the trapping area with the outlet.

13. The microfluidic cartridge of claim 12, further comprising an analysis portion coupled to the outlet of the immobilizer to receive and flow the prepared sample into an interrogation area for analysis.

14. The microfluidic cartridge of claim 13, wherein the analyzer is a flow cytometer.

15. The microfluidic cartridge of claim 13, further comprising a discharge channel coupled to the outlet of the immobilizer, the discharge channel being configured to flow the one or more reagents out thereof to waste away from the analyzer.

16. A method for preparing a sample automatically in a microfluidic cartridge, the method comprising:
introducing an initial sample into an immobilizer;
immobilizing the initial sample in the immobilizer;
introducing one or more reagents from one or more reagent reservoirs through the immobilizer to react with the initial sample to form a prepared sample while the one or more reagents flow through the immobilizer; and
releasing the prepared sample into a downstream analysis portion by removing the magnetic field from the immobilizer.

17. The method of claim 16, further comprising flowing excess amounts of the one or more reagents out of the immobilizer through a discharge channel to waste after each reagent is introduced into the immobilizer and before a subsequent reagent is introduced into the immobilizer.

18. The method of claim 16, further comprising incubating the initial sample with a plurality of magnetic particles and introducing the initial sample and magnetic particles into the immobilizer together.

19. The method of claim 16, wherein introducing the initial sample into the immobilizer comprises:
introducing a plurality of magnetic particles into the immobilizer, the plurality of magnetic particles being immobilized therein by the magnetic field; and
introducing the initial sample into the immobilizer, the initial sample being captured by the magnetic particles.

20. The method of claim 16, wherein some amount of liquid of the sample remains in a sample reservoir after introducing the initial sample into the immobilizer and some amount of liquid of the one or more reagents remains in the one or more reagent reservoirs after introducing the one or more reagents through the immobilizer.

21. The method of claim 16, wherein the one or more reagents are introduced through the immobilizer sequentially.
